(19) United States
(12) Patent Application Publication
(10) Pub. No.: US 2016/0176743 A1
(43) Pub. Date: Jun. 23, 2016

(54) METHOD AND APPARATUS FOR CULTURE OF ANAEROBIC AMMONIUM OXIDIZER

(71) Applicant: Korea Institute of Science and Technology, Seoul (KR)

(72) Inventors: Hyokwan BAE, Seoul (KR); Seockheon LEE, Seoul (KR); Yun Chul CHUNG, Seoul (KR); Jin-Young JUNG, Daegu (KR); Hee Jeong YANG, Goyang-si (KR)

(73) Assignee: Korea Institute of Science and Technology, Seoul (KR)

(21) Appl. No.: 14/840,664

(22) Filed: Aug. 31, 2015

(30) Foreign Application Priority Data
Dec. 22, 2014 (KR) 10-2014-0185833

(51) Int. Cl. C02F 11/04

(52) U.S. Cl. CPC C02F 11/04

(57) ABSTRACT

The present disclosure provides an apparatus for enrichment culturing of anaerobic ammonium-oxidizing bacteria, including: a reactor containing a culture medium containing ammonium and nitrite; and activated sludge beads in which the anaerobic ammonium-oxidizing bacteria in the culture medium are supported, wherein the amount of the activated sludge beads is 25-35% based on the volume of the culture medium. Because loss of the anaerobic ammonium-oxidizing bacteria is minimized and the beads have good mechanical strength, the apparatus for enrichment culturing of anaerobic ammonium-oxidizing bacteria can be operated for a long time.

### CROSS-REFERENCE TO RELATED APPLICATIONS

This application claims, under 35 U.S.C. §119, the priority of Korean Patent Application No. 10-2014-0185833, filed on Dec. 22, 2014, in the Korean Intellectual Property Office, the disclosure of which is incorporated herein by reference in its entirety.

### TECHNICAL FIELD

The present disclosure relates to a method and an apparatus for enrichment culturing of anaerobic ammonium-oxidizing bacteria, more particularly to a method and an apparatus for enrichment culturing of anaerobic ammonium-oxidizing bacteria, wherein an activated sludge containing anaerobic ammonium-oxidizing bacteria is beaded and the anaerobic ammonium-oxidizing bacteria are cultured using the beaded activated sludge under optimized beading and culturing conditions such as total nitrogen concentration, total nitrogen inflow rate, pH, etc. so that the anaerobic ammonium-oxidizing bacteria can be enrichment cultured in short time.

### BACKGROUND

As methods for removing nitrogen from sewage and wastewater, biological processes using nitrification and denitrification reactions are widely used. The nitrification reaction is composed of ammonia oxidation followed by nitrite oxidation. The oxidation of nitrogen through the ammonia oxidation and nitrite oxidation reactions requires a large quantity of oxygen. And, the denitrification reaction requires an organic carbon source as an electron donor for reduction of nitrate or nitrite. Although relatively inexpensive methanol is usually used as the organic carbon source, it is burden to the operational cost because continuous supply is necessary.

To cope with these problems of the biological processes, a method for removing nitrogen using anaerobic ammonium-oxidizing bacteria is studied intensely recently (e.g., Korean Patent Registration No. 1040518). The anaerobic ammonium-oxidizing bacteria are autotrophic microorganisms that produce nitrogen (N₂) under anaerobic conditions using ammonium (NH₄⁺) and nitrite (NO₂⁻) as substrates. Since the anaerobic ammonium-oxidizing bacteria use ammonium (NH₄⁺) as an electron donor and nitrite (NO₂⁻) as an electron acceptor, the addition of an organic carbon source is unnecessary unlike the conventional biological processes. Also, since the amount of oxygen required for the partial nitrification of ammonia nitrogen is about 40% as compared to the conventional biological processes, it is advantageous in that the cost of aeration and carbon source supply can be reduced.

In addition, the maximum nitrogen removal efficiency of the nitrogen removal process using the anaerobic ammonium-oxidizing bacteria is very superior as 26-42 kg N/m³·day, whereas that of the conventional biological processes does not exceed 3 kg N/m³·day.

In the wastewater treatment processes and in the nitrogen cycle of the nature, Candidatus Brocadia, Candidatus Kuenenia, Candidatus Scalindua, Candidatus Anammoxoglobus, Candidatus Jettenia, etc. are known as the anaerobic ammonium-oxidizing bacteria. Because their growth rate is very slow with a doubling time of about 11 days, a long time is required until the nitrogen removal reaction by the anaerobic ammonium-oxidizing bacteria reaches a predetermined level. It was reported, in the first case where the anaerobic ammonium-oxidizing bacteria were applied, that an additional, continuous supply of the anaerobic ammonium-oxidizing bacteria was necessary for over a year (Van der Star W R, Abma W R, Blommers D, Mulder J W, Tokutomi T, Strous M, Picioreanu C, van Loosdrecht M C (2007) Startup of reactors for anoxic ammonium oxidation: experiences from the first full-scale anammox reactor in Rotterdam. Water Research 41: 4149-4163).

The startup time of the anaerobic ammonium oxidation process is affected by reactor type, wastewater quality, stability of the process conditions, etc. In particular, the immobilization technique of allowing the anaerobic ammonium-oxidizing bacteria to be retained in the reactor is the most important factor. At present, the most widely used immobilization technique is to induce granulation by facilitating aggregation. However, a very complicated operating condition has to be maintained for aggregation of the bacteria and it takes 3-6 months for the aggregation. In addition, additional cost and time are required for doubling the aggregated granular sludge and it is not suitable to obtain the anaerobic ammonium-oxidizing bacteria in large quantities in short time.

### REFERENCES OF THE RELATED ART

Patent Document

Korean Patent Registration No. 1040518

Non-Patent Document

Van der Star W R, Abma W R, Blommers D, Mulder J W, Tokutomi T, Strous M, Picioreanu C, van Loosdrecht M C (2007) Startup of reactors for anoxic ammonium oxidation: experiences from the first full-scale anammox reactor in Rotterdam. Water Research 41: 4149-4163.

### SUMMARY

The present disclosure is directed to providing a method and an apparatus for enrichment culturing of anaerobic ammonium-oxidizing bacteria, wherein an activated sludge containing anaerobic ammonium-oxidizing bacteria is beaded and the anaerobic ammonium-oxidizing bacteria are cultured using the beaded activated sludge under optimized beading and culturing conditions such as total nitrogen concentration, total nitrogen inflow rate, pH, etc. so that the anaerobic ammonium-oxidizing bacteria can be enrichment cultured in short time.

The present disclosure is also directed to providing a method and an apparatus for enrichment culturing of anaerobic ammonium-oxidizing bacteria, wherein a single reactor is operated either as a completely stirred tank reactor (CSTR) or a sequencing batch reactor (SBR).

The method for enrichment culturing of anaerobic ammonium-oxidizing bacteria according to the present disclosure includes a step of preparing activated sludge beads in which anaerobic ammonium-oxidizing bacteria are supported and a step of enrichment culturing the anaerobic ammonium-oxidizing bacteria in the activated sludge beads by adding the activated sludge beads to a culture medium containing ammonium and nitrite.

The step of preparing the activated sludge beads in which the anaerobic ammonium-oxidizing bacteria are supported may include preparing a PVA-alginate mixture solution containing PVA (poly(vinyl alcohol)) and alginate, preparing an activated sludge beading solution by mixing the PVA-alginate mixture solution with an activated sludge containing anaerobic ammonium-oxidizing bacteria, forming activated sludge beads by adding the activated sludge beading solution to a saturated boric acid solution containing calcium chloride, and enhancing the mechanical strength of the activated sludge beads by immersing the activated sludge beads in a phosphoric acid solution.

Solid particles may be contained in the PVA-alginate mixture solution or the activated sludge beading solution. And, the PVA-alginate mixture solution may be a solution wherein PVA (poly(vinyl alcohol)) and alginate are mixed in distilled water. Solid particles may be contained in the PVA-alginate mixture solution, at a ratio of 0.5-5 g of the solid particles per 100 g of the distilled water. The solid particles may have a size of from 10 μm to 1 mm.

After the activated sludge beads have been formed, pores may be formed in the activated sludge beads by desorbing the solid particles from the activated sludge beads.

The culture medium and the activated sludge beads are provided in a reactor. The reactor is operated as a completely stirred tank reactor (CSTR) and the total nitrogen inflow rate is controlled to be 0.8-1.5 kg N/m³·day. Alternatively, the culture medium and the activated sludge beads are provided in a reactor which is operated as a sequencing batch reactor (SBR). In this case, the in the total nitrogen concentration in the culture medium in the reactor may be maintained at 120-180 mg N/L.

The volume of the liquid flowing into the reactor is the same as the volume of the liquid flowing out of the reactor. And, when the reactor is operated as a sequencing batch reactor (SBR), the pH of the culture medium is 6.5-8.

When adding the activated sludge beads to the culture medium, the amount of the activated sludge beads may be 25-35% based on the volume of the culture medium. The ammonium of the culture medium may be supplied as (NH₄)SO₄ and the nitrite may be supplied as NaNO₂.

In another aspect, the present disclosure provides an apparatus for enrichment culturing of anaerobic ammonium-oxidizing bacteria, including: a reactor containing a culture medium containing ammonium and nitrite; and activated sludge beads in which the anaerobic ammonium-oxidizing bacteria in the culture medium are supported, wherein the amount of the activated sludge beads is 25-35% based on the volume of the culture medium.

The activated sludge beads are formed by mixing and hardening PVA (poly(vinyl alcohol)), alginate and an activated sludge. A filtering sieve preventing outflow of the activated sludge beads may be provided on top of the reactor.

The method and apparatus for enrichment culturing of anaerobic ammonium-oxidizing bacteria according to the present disclosure provide the following advantageous effects.

As the activated sludge containing the anaerobic ammonium-oxidizing bacteria is prepared into beads, loss of the anaerobic ammonium-oxidizing bacteria can be minimized. Furthermore, because the beads have good mechanical strength, the apparatus for enrichment culturing of anaerobic ammonium-oxidizing bacteria can be operated for a long time. In addition, the anaerobic ammonium-oxidizing bacteria with maximum nitrogen removal activity can be enrichment cultured in short time by culturing them under optimized culturing conditions.

### BRIEF DESCRIPTION OF DRAWINGS

FIG. 1 is a flow chart for describing a method for enrichment culturing of anaerobic ammonium-oxidizing bacteria according to an exemplary embodiment of the present disclosure.

FIG. 2 is a flow chart for describing a process for preparing activated sludge beads according to an exemplary embodiment of the present disclosure.

FIG. 3 shows a result of analyzing the mechanical strength of beads depending on reaction time using the response surface methodology.

FIG. 4 shows an SEM image of completed activated sludge beads.

FIG. 5 shows an SEM image of activated sludge beads prepared by using an activated sludge beading solution in which activated carbon is mixed.

FIG. 6 shows the growth rate of anaerobic ammonium-oxidizing bacteria when the total nitrogen inflow rate is 0.32 kg N/m³·day.

FIG. 7 shows the growth rate of anaerobic ammonium-oxidizing bacteria when the total nitrogen inflow rate is 0.81 kg N/m³·day.

FIG. 8 shows a result of performing a nitrogen removal experiment for 107 days by increasing the total nitrogen concentration at the time when nitrogen removal activity is exhibited.

FIG. 9 shows a result of statistical analysis for optimizing the total nitrogen concentration and pH.

FIG. 10 shows the exponential growth rate depending on the diameter of activated sludge beads.

FIG. 11 shows the inverse relationship between the constant A/V of activated sludge beads and the lag period.

FIG. 12 shows a result of culturing for 200 days.

FIG. 13 is a perspective view of an apparatus for enrichment culturing of anaerobic ammonium-oxidizing bacteria according to an exemplary embodiment of the present disclosure.

FIG. 14 shows is a front view of an apparatus for enrichment culturing of anaerobic ammonium-oxidizing bacteria according to an exemplary embodiment of the present disclosure.

FIG. 15 is a perspective view of a filtering sieve.

### DETAILED DESCRIPTION OF EMBODIMENTS

The present disclosure provides a technology of enrichment culturing anaerobic ammonium-oxidizing bacteria by beading an activated sludge which contains anaerobic ammonium-oxidizing bacteria. Specifically, it provides optimized total nitrogen concentration, total nitrogen inflow rate and pH conditions for enrichment culturing of the anaerobic ammonium-oxidizing bacteria and also provides a bead preparation process whereby the mechanical strength of beads in which the activated sludge is supported can be enhanced. Hereinafter, a method and an apparatus for enrichment culturing of anaerobic ammonium-oxidizing bacteria according to an exemplary embodiment of the present disclosure will be described in detail referring to the attached drawings.

As shown in FIG. 1, a method for enrichment culturing of anaerobic ammonium-oxidizing bacteria according to an exemplary embodiment of the present disclosure includes 1) a step of preparing activated sludge beads (S101) and 2) a step of enrichment culturing microorganisms (S102).

First, the step 1) of preparing activated sludge beads will be described. In the step of preparing activated sludge beads, an activated sludge containing anaerobic ammonium-oxidizing bacteria is beaded.

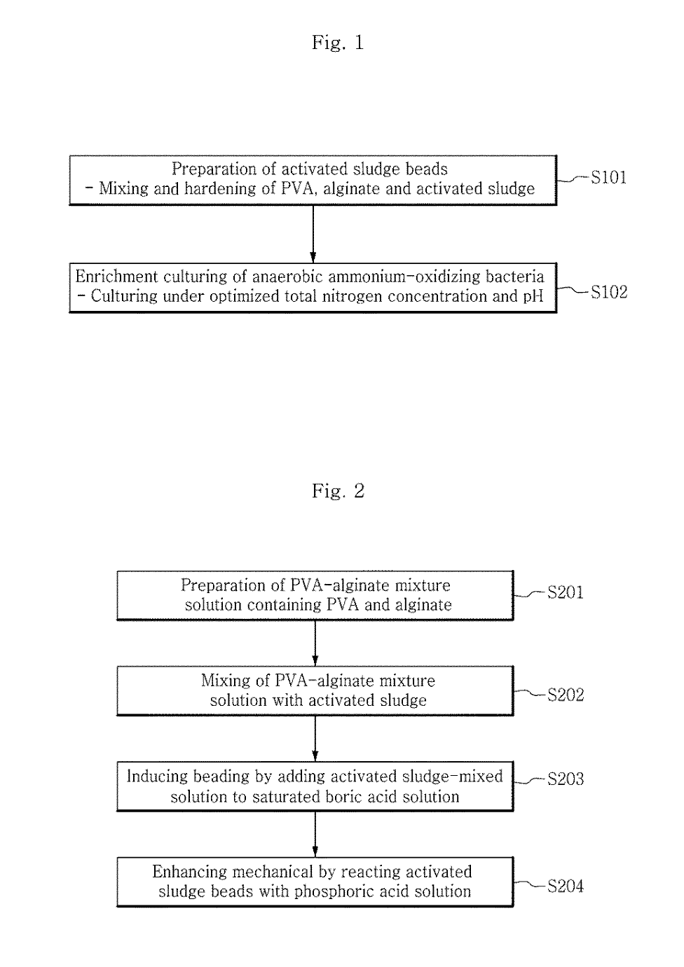

Referring to FIG. 2, a PVA-alginate mixture solution and an activated sludge are prepared to prepare the activated sludge beads (S201). The PVA-alginate mixture solution is a solution in which PVA (poly(vinyl alcohol)) and alginate are mixed in distilled water. The PVA-alginate mixture solution may be a solution in which 10-20 g of PVA and 1-5 g of sodium alginate are mixed per 100 g of distilled water. For uniform mixing of the PVA and the alginate, the PVA-alginate mixture solution may be prepared by dissolving at 100° C. or above for a predetermined time.

Then, the PVA-alginate mixture solution is mixed with the activated sludge (S202). The PVA-alginate mixture solution and the activated sludge may be mixed at a volume ratio of 1:1. Hereinafter, the solution obtained by mixing the PVA-alginate mixture solution with the activated sludge is referred to as an ‘activated sludge beading solution’.

The activated sludge is a sludge containing anaerobic ammonium-oxidizing bacteria. Specifically, a high-concentration activated sludge may be used in order to increase the culturing speed of the anaerobic ammonium-oxidizing bacteria. The high-concentration activated sludge may be prepared through gravitational precipitation or centrifugation. In order to increase the content of the initially supported anaerobic ammonium-oxidizing bacteria, the concentration of volatile suspended solids (VSS) in the activated sludge should be increased to 5-10 VSS g/L. And, in order to select the activated sludge most suitable for enrichment culturing from among various activated sludges, molecular biological techniques such as PCR, real-time PCR, etc. may be utilized to investigate the growth and content of anaerobic ammonium-oxidizing bacteria. For example, ‘Method for searching for and culturing anaerobic ammonium-oxidizing bacteria in microbiological resources’ disclosed in Korean Patent Registration No. 1040518, which was filed by the inventors of the present disclosure, may be consulted.

The activated sludge beading solution in viscous liquid state is added to a saturated boric acid (H₃BO₃) solution which contains 0.5-1 g of calcium chloride (CaCl₂) per 100 g of distilled water (S203). The calcium chloride and the saturated boric acid serve as crosslinking agents that make the mixture solution into beads. The calcium chloride serves as a crosslinking agent for the alginate and the saturated boric acid serves as a crosslinking agent for the PVA.

The activated sludge beads may be formed by adding the activated sludge beading solution to the saturated boric acid solution. The size of the beads may be controlled considering the reaction efficiency of the anaerobic ammonium-oxidizing bacteria, etc. The reaction efficiency of the anaerobic ammonium-oxidizing bacteria increases as the size of the beads is smaller. However, the size of the beads may be specifically about 1-2 mm in order to prevent outflow of the beads from the reactor. The size of the beads may be controlled using a needle, a tube or a funnel. And, the mechanical strength may be controlled with the time for reaction between the activated sludge beading solution and the saturated boric acid solution.

After the activated sludge beads have been completed, the activated sludge beads are immersed in a 0.5-1 M phosphoric acid (KH₂PO₄) solution to further enhance the mechanical strength of the beads (S204).

Since the anaerobic ammonium-oxidizing bacteria in the activated sludge beads are enrichment cultured in the subsequent step of culturing the anaerobic ammonium-oxidizing bacteria and the activated sludge beads having the anaerobic ammonium-oxidizing bacteria enrichment cultured should be used for a long time in the actual process, it is necessary to maximize the mechanical strength of the beads. As described above, the mechanical strength of the beads is enhanced through the beading reaction between the activated sludge beading solution and the saturated boric acid solution and the strengthening reaction between the beads and the phosphoric acid solution. In order to achieve the maximum mechanical strength in minimum reaction time, TCOD measurement and the response surface methodology may be used. Through this, the minimum reaction time to ensure the maximum mechanical strength may be derived.

Specifically, a solution prepared by adding 100 activated sludge beads to 40 mL of distilled water may be subjected to pulverization using a high-speed homogenizer and the resulting pulverized beads may be subjected to TCOD measurement. The reaction time may be optimized using the response surface methodology. A multi-dimensional function for the response surface methodology is given in Equation 1. And, the experimental condition for the response surface methodology is given in Table 1.

$${η}_{a} = {C}_{0} + {\sum }_{j = 1}^{n} {α}_{i} {x}_{i} + {\sum }_{i = 1}^{n} α \text{?} {x}_{i}^{2} + {\sum }_{i} {\sum }_{j} {α}_{ij} {x}_{i} {x}_{j} , \\ i < j \\ \text{?} \text{indicates text missing or illegible when filed} \qquad ( Equation 1 )$$

(η_{α} is the TCOD concentration (mg/L) resulting from the pulverized gel pieces. xₖ is the independent variable of the function, x₁ is the beading reaction time, x₂ is the strengthening reaction time, C₀ is the error term occurring during regression analysis, and αₖ is the constant for each independent variable.)

TABLE 1

| | Independent variable | | |
|---|---|---|---|
| | Beading reaction | Strengthening reaction | Dependent variable |
| No. | time (x₁, hr) | time (x₂, hr) | TCOD (mg/L) |
| 1 | 2.0 | 2.0 | 171 |
| 2 | 5.0 | 2.0 | 152 |
| 3 | 2.0 | 5.0 | 148 |
| 4 | 5.0 | 5.0 | 115 |
| 5 | 3.5 | 3.5 | 166.3 ± 3.06 |
| 6 | 5.6 | 3.5 | 116 |
| 7 | 1.4 | 3.5 | 201 |
| 8 | 3.5 | 5.6 | 101 |
| 9 | 3.5 | 1.4 | 187 |

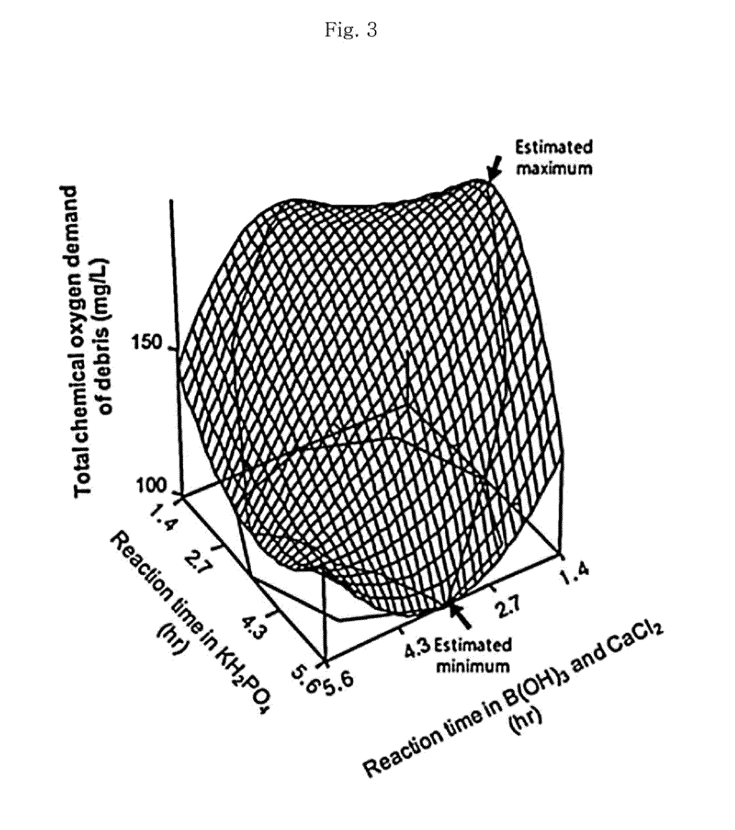

As a result of regression analysis based on the measured values, a multi-dimensional function is derived as given in Equation 2 and a response surface created thereby is shown in FIG. 3. The condition under which the lowest TCOD concentration is achieved corresponds to the highest mechanical strength. From the TCOD measurement and the response surface methodology, the beading reaction time and the strengthening reaction time are determined as 3.5 hours and 5.6 hours, respectively. Accordingly, the optimal beading reaction time is specifically 3-4 hours and the optimal strengthening reaction time is specifically 5-6 hours.

η_{residual TCOD}=166-29.2 x₁−20.5 x₂−1.56 x₁ x₂−2.29 x₁²−5.58 x₂²+4.66 x₁² x₂+5.14 x₁ x₂² (Equation 2)

When culturing the anaerobic ammonium-oxidizing bacteria using the completed activated sludge beads, nitrogen gas is generated as the anaerobic ammonium-oxidizing bacteria in the activated sludge beads grow using ammonium and nitrite as substrates. Unless the nitrogen gas is released out of the beads, the beads themselves expand. For effective release of the nitrogen gas, a migration path for the nitrogen gas should be provided in the beads. In the present disclosure, solid particles of a predetermined size are mixed in the activated sludge beading solution for this purpose.

When the activated sludge beads is completed in the state where the solid particles are included in the activated sludge beading, the solid particles are desorbed from the activated sludge beads by external physical impact above a predetermined level because the solid particles do not form chemical bonds with the PVA or the alginate. As a result, pores that spatially connect the inside and outside of the activated sludge beads are formed at the sites where the solid particles are desorbed, which serve as a migration path for nitrogen gas. The external physical impact above a predetermined level may refer to a contact between a stirrer and the activated sludge beads owing to the operation of the stirrer during the subsequent step of enrichment culturing microorganisms, a contact between the activated sludge beads owing to the operation of the stirrer, or external physical impact for desorbing the solid particles from the activated sludge beads.

The solid particles may be added to and mixed in the activated sludge beading solution, or may be mixed in advance in the PVA-alginate mixture solution. And, the solid particles may be formed of a material that does not react chemically with PVA or alginate. In an exemplary embodiment of the present disclosure, activated carbon with a size of from 10 μm to 1 mm may be used. When the solid particles are mixed in the PVA-alginate mixture solution, the amount of the solid particles may be 0.5-5 g based on 100 g of distilled water. If the content of the solid particles in the PVA-alginate mixture solution exceeds 5%, beads are not formed because of increased viscosity.

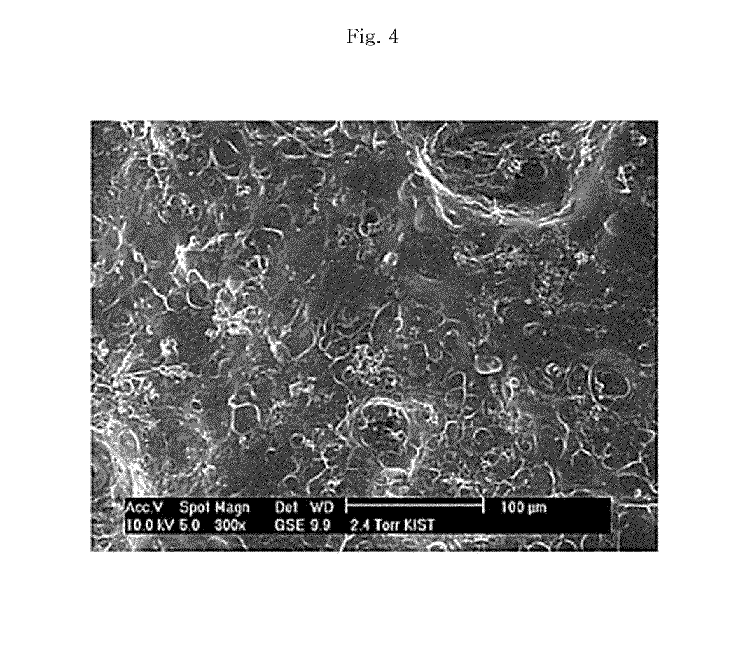

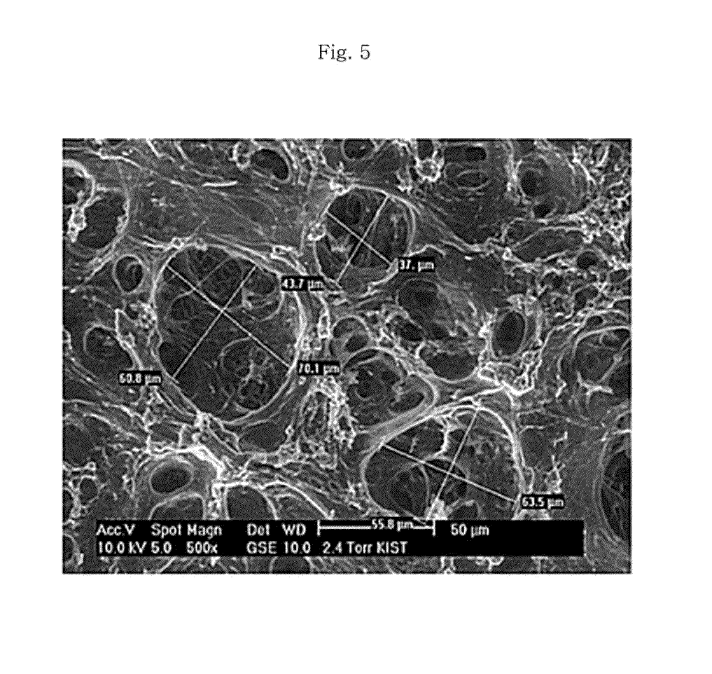

FIG. 4 shows an SEM image of the completed activated sludge beads and FIG. 5 shows an SEM image of the activated sludge beads prepared by using the activated sludge beading solution in which activated carbon is mixed. It can be seen from FIG. 5 that pores with a size of 40-70 μm have been formed on the surface of the activated sludge beads.

After the activated sludge beads have been prepared in the step 1) of preparing activated sludge beads, the step 2) of enrichment culturing microorganisms is conducted. The step 2) of enrichment culturing microorganisms is a process in which the anaerobic ammonium-oxidizing bacteria in the activated sludge beads are enrichment cultured.

The step 2) of enrichment culturing microorganisms is conducted in a reactor. Specifically, after adding the activated sludge to a reactor containing a culture medium, the anaerobic ammonium-oxidizing bacteria in the activated sludge beads are cultured for a predetermined time.

The anaerobic ammonium-oxidizing bacteria grow using ammonium and nitrite as substrates. Accordingly, the culture medium in the reactor contains ammonium and nitrite. The sources of the ammonium and the nitrite may be (NH₄)SO₄ and NaNO₂, respectively. In addition, a predetermined amount of carbon, phosphorus, magnesium and calcium and a trace amount of minerals may be included in the culture medium.

When adding the activated sludge beads to the reactor, the amount of the activated sludge is about 25-35% based on the volume of the culture medium. If the addition amount of the activated sludge beads is greater than 35% based on the volume of the culture medium, nitrogen removal activity may decrease.

Since the substrates (ammonium and nitrite) are consumed as the anaerobic ammonium-oxidizing bacteria grow, the total nitrogen concentration of the culture medium should be maintained above a predetermined level for continuous growth of the anaerobic ammonium-oxidizing bacteria. To maintain the total nitrogen concentration of the culture medium above a predetermined level, it is necessary to additionally supply the nitrogen substrates into the reactor. The culture medium having the substrates consumed is discharged from the reactor and a fresh culture medium containing substrates is supplied to the reactor.

The method for additionally supplying the nitrogen substrates into the reactor is different depending on the operation type of the reactor. In the present disclosure, the reactor may be operated either as a completely stirred tank reactor (CSTR) or as a sequencing batch reactor (SBR). The completely stirred tank reactor (CSTR) supplies the culture medium continuously and the sequencing batch reactor (SBR) supplies the culture medium intermittently with time predetermined intervals. The specific operation methods of the completely stirred tank reactor (CSTR) and the sequencing batch reactor (SBR) are as follows.

First, when the reactor is operated as a completely stirred tank reactor (CSTR), suppose that 25-35% of the activated sludge beads are added based on the volume of the culture medium, the total nitrogen inflow rate, i.e. the rate at which the nitrogen substrates are additionally and continuously supplied to the reactor, should be controlled to be 0.8-1.5 kg N/m³·day. In this case, it is assumed that the volume of the liquid (culture medium) flown into the reactor is the same as the volume of the liquid (used culture medium) flown out of the reactor.

Next, when the reactor is operated as a sequencing batch reactor (SBR), suppose that 25-35% of the activated sludge beads are added based on the volume of the culture medium, the nitrogen removal activity of the anaerobic ammonium-oxidizing bacteria is maximized when the total nitrogen concentration in the culture medium in the reactor is maintained at 120-180 mg N/L. In addition, in order to further increase the nitrogen removal activity, pH may be adjusted to 6.5-8. These total nitrogen concentration and pH conditions are supported by the experimental results described below. For reference, if the total nitrogen concentration of the culture medium is 180 mg N/L or higher and if the pH is 8 or higher, the growth of the microorganisms is negatively affected due to ammonia toxicity. And, if the total nitrogen concentration is lower than 120 mg N/L, the growth rate decreases due to insufficiency of the substrates.

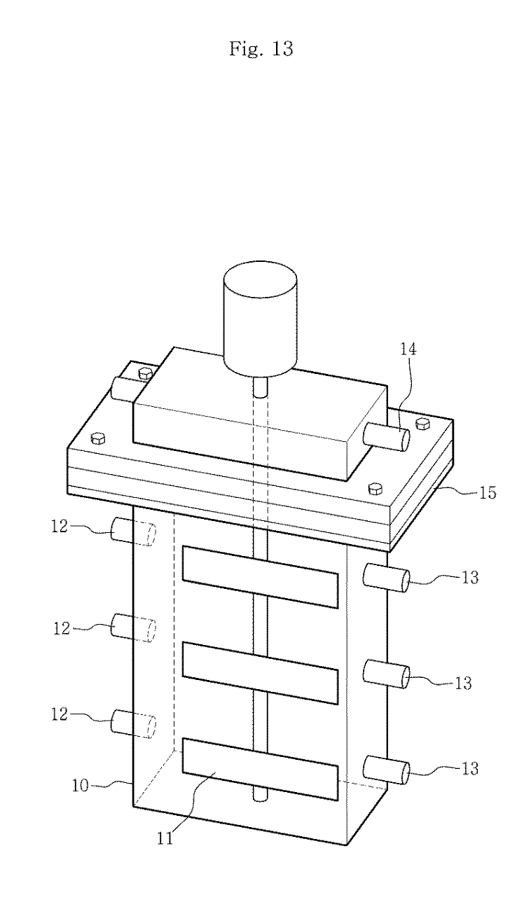

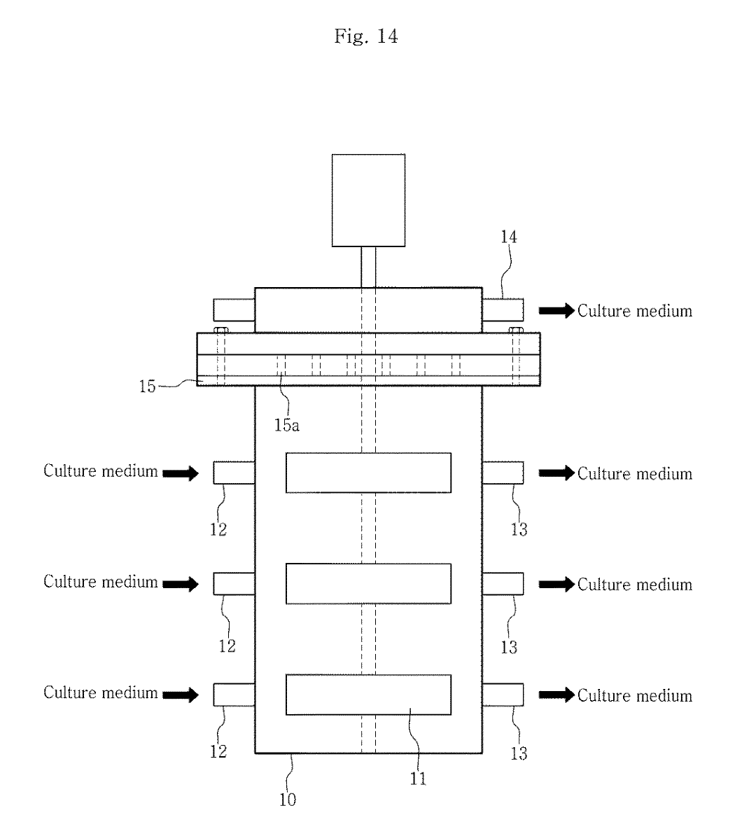

Specifically, the reactor may be configured as follows. As seen from FIG. 13 and FIG. 14, the reactor 10 provides a space for culturing the anaerobic ammonium-oxidizing bacteria and the culture medium and the activated sludge beads (not shown) are provided in the reactor 10 as described above. Also, a stirrer 11 which induces contact between the culture medium and the activated sludge beads is provided in the reactor 10.

A culture medium inlet 12 is provided on one side of the reactor 10 and a culture medium outlet is provided on the other side. The culture medium outlet may be either a CSTR outlet 14 through which the culture medium is flown out when the reactor is operated as a completely stirred tank reactor (CSTR) or an SBR outlet 13 through which the culture medium is flown out when the reactor is operated as a sequencing batch reactor (SBR). When the reactor is operated as a completely stirred tank reactor (CSTR), the culture medium is supplied to the culture medium inlet 12 and the culture medium in the reactor 10 is flown out through the CSTR outlet 14. And, when the reactor is operated as a sequencing batch reactor (SBR), after the culture medium is supplied, the culture medium is flown out through the SBR outlet 13 after a predetermined time.

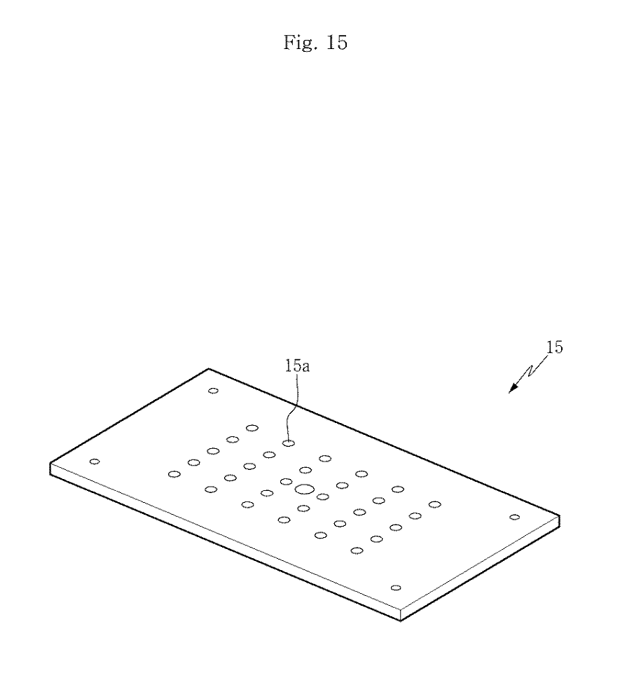

A filtering sieve 15 for preventing outflow of the activated sludge beads is provided on top of the reactor 10. The filtering sieve 15 is provided with culture medium outflow holes 15a through which the culture medium can pass (see FIG. 15). In addition, the reactor 10 may be further equipped on the rear side with a microorganism recovery device (not shown) in which a material with a large surface area, such as a nonwoven, is filled. The microorganism recovery device allows for recovery of the anaerobic ammonium-oxidizing bacteria flowing out as being included in the culture medium.

Hereinafter, the method for enrichment culturing of anaerobic ammonium-oxidizing bacteria according to an exemplary embodiment of the present disclosure will be described in further detail through experimental examples.

### EXPERIMENTAL EXAMPLE 1

### Preparation of Activated Sludge Beads

A solution in which 10-20 g of PVA and 1-5 g of sodium alginate are mixed in 250 mL of distilled water was prepared by dissolving in an autoclave at 121° C. for 30 minutes. After cooling to 40° C., the PVA-alginate mixture solution was mixed with an activated sludge and then dropped onto a saturated boric acid (H₃BO₃) solution (a saturated boric acid solution continuing 0.5-1 g of calcium chloride per 100 g of distilled water) using a metering pump to prepare activated sludge beads. The prepared activated sludge beads were reacted with a 0.5-1 M phosphoric acid (KH₂PO₄) solution to enhance mechanical strength. FIG. 4 is an SEM image of the activated sludge beads prepared in Experimental Example 1.

### EXPERIMENTAL EXAMPLE 2

### Culturing of Anaerobic Ammonium-Oxidizing Bacteria

The activated sludge beads prepared in Experimental Example 1 were added to a reactor containing a culture medium. The culture medium consisted primarily of 96 mg C/L of NaHCO₃, 6 mg P/L, 12 mg Mg/L and 48 mg Ca/L and was supplemented with 1 mL of trace mineral I solution and 1 mL of a trace mineral II solution. The trace mineral I solution contained 5 g/L EDTA and 5 g/L FeSO₄.7H₂O, and the trace mineral II solution contained 5 g/L EDTA, 0.43 g/L ZnSO₄.7H₂O, 0.24 g/L CoCl₂.6H₂O, 0.99 g/L MnCl₂.4H₂O, 0.25 g/L CuSO₄.5H₂O, 0.22 g/L Na₂MoO₄.2H₂O, 0.19 g/L NiCl₂.6H₂O, 0.21 g/L Na₂SeO₄.10H₂O and 0.014 g/L H₃BO₃. During the culturing, (NH₄)SO₄ and NaNO₂ were additionally supplied to the culture medium as sources of ammonium and nitrite, respectively.

### EXPERIMENTAL EXAMPLE 3

### Result of Culturing Using Completely Stirred Tank Reactor (CSTR) Depending on Total Nitrogen Inflow Rate

Anaerobic ammonium-oxidizing bacteria were cultured according to the method described in Experimental Example 2. The culturing was performed while varying the total nitrogen inflow rate at 0.32 kg N/m³·day and 0.81 kg N/m³·day. The reactor was maintained at 35° C. in the dark and the pH of the culture medium was not controlled. The growth rate of the anaerobic ammonium-oxidizing bacteria was calculated through interpolation and regression analysis of the exponential growth of the nitrogen removal efficiency.

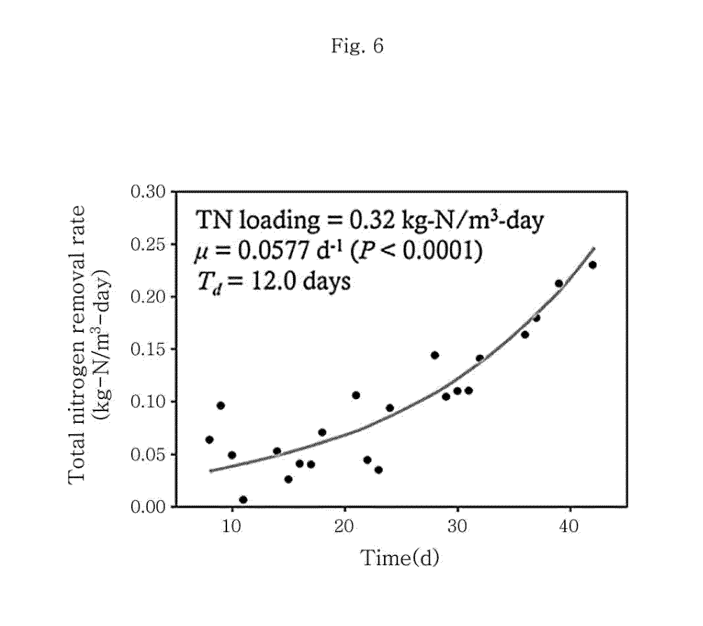

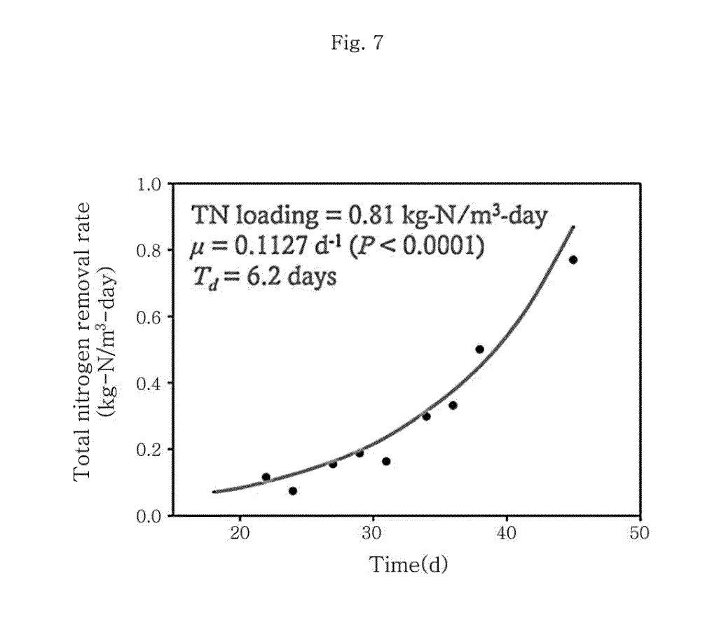

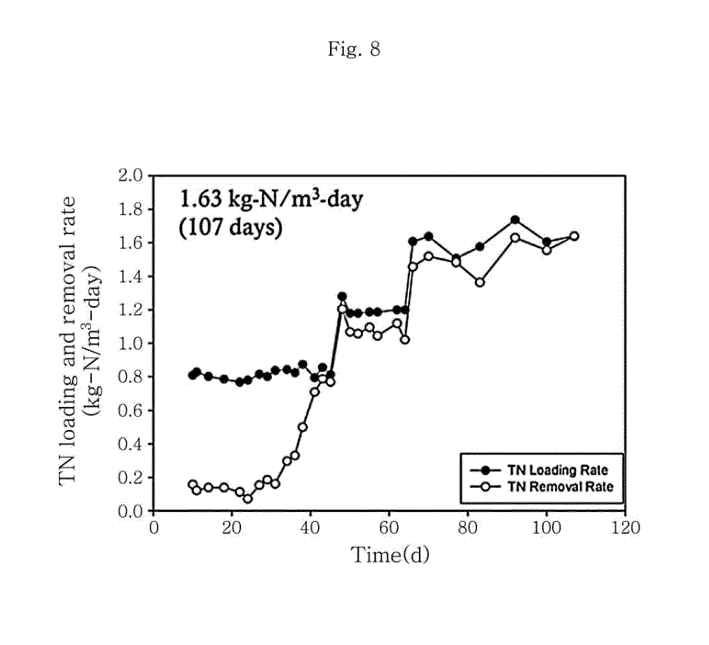

FIG. 6 shows the growth rate of the anaerobic ammonium-oxidizing bacteria when the total nitrogen inflow rate was 0.32 kg N/m³·day, and FIG. 7 shows the growth rate of the anaerobic ammonium-oxidizing bacteria when the total nitrogen inflow rate was 0.81 kg N/m³·day. Referring to FIG. 6 and FIG. 7, it can be seen that a much better exponential growth rate was achieved when the total nitrogen inflow rate was 0.81 kg N/m³·day. Whereas the doubling time (T_{d}) was 12.0 days when the total nitrogen inflow rate was 0.32 kg N/m³·day, the doubling time (T_{d}) was only 6.2 days when the total nitrogen inflow rate was 0.81 kg N/m³·day, indicating that the growth rate increases with the total nitrogen inflow rate.

In addition, it was confirmed that the nitrogen removal efficiency can be improved by slowly increasing the total nitrogen inflow rate from the time when anaerobic ammonium oxidation begins to occur. As seen from FIG. 8, it was confirmed that a removal efficiency as high as 1.63 kg N/m³·day could be achieved through operation for 107 days.

### EXPERIMENTAL EXAMPLE 4

### Establishment of Optimal Total Nitrogen Concentration and pH Conditions for Sequencing Batch Reactor (SBR)

With the ratio of ammonia nitrogen and nitrite nitrogen fixed at 1:1, the anaerobic ammonium oxidation activity was measured while varying the total nitrogen concentration and pH as described in Table 2 in order to find the optimal conditions. For analysis of the experimental result, regression analysis was conducted using the response surface methodology.

TABLE 2

| | Independent variable | | Dependent variable |
|---|---|---|---|
| | Total nitrogen concentration | pH | Nitrogen |
| No. | (x₁, mg N/L) | (x₂,) | removal activity |
| 1 | 220 | 8 | 1.30 |
| 2 | 220 | 6 | 1.29 |
| 3 | 100 | 8 | 1.41 |
| 4 | 100 | 6 | 1.49 |
| 5 | 160 | 7 | 1.70 ± 0.06 |
| 6 | 244.8 | 7 | 0.99 |
| 7 | 75.2 | 7 | 1.27 |
| 8 | 160 | 8.4 | 1.34 |
| 9 | 160 | 5.6 | 0.43 |

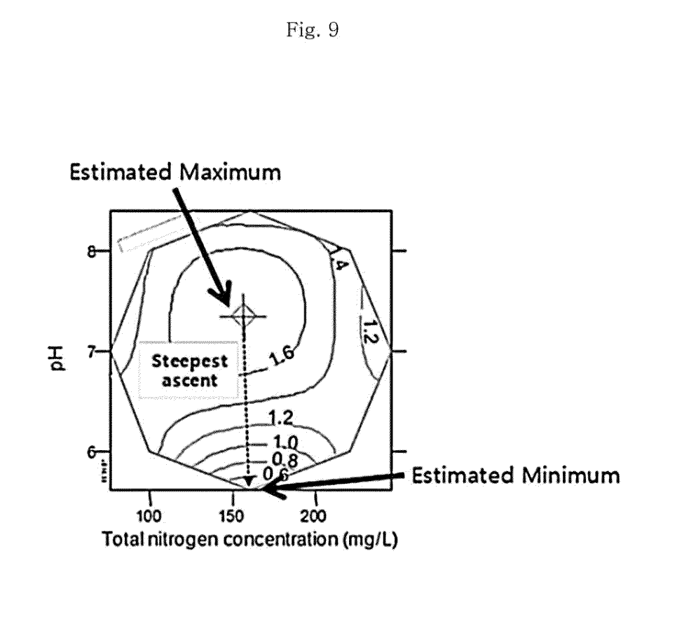

Equation 3 was derived as a result of the regression analysis and the analyzed optimal conditions are shown in FIG. 9. Referring to FIG. 9, an anaerobic ammonium oxidation activity of 1.6 kg N/L·mg VSS·day or higher was achieved when the total nitrogen concentration was 120-180 mg N/L and the pH was 6.8-7.8. When these conditions are maintained, enrichment culturing is possible with the activity of the anaerobic ammonium-oxidizing bacteria maximized.

η_{residual ANNAMOX}=1.70-1.65×10⁻³ x₁+3.27×10⁻¹ x₂+3.61×10⁻⁴ x₁ x₂−7.91×10⁻⁵ x₁²−4.14×10⁻¹ x₂²−9.59×10⁻⁵ x₁²x₂+3.82×10⁻⁴ x₁ x₂²+1.04×10⁻⁴ x₁²x₂² (Equation 3)

### EXPERIMENTAL EXAMPLE 5

### Growth Rate Depending on Diameter of Activated Sludge Beads

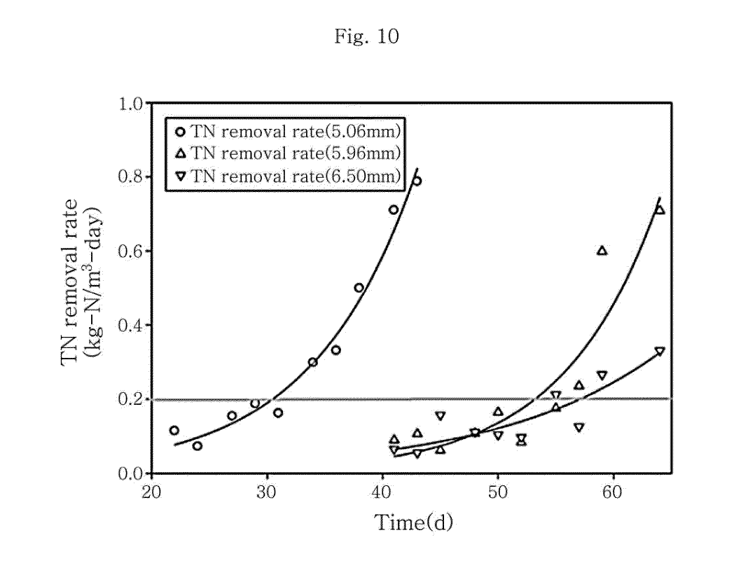

In order to prevent the decrease of the growth rate of the anaerobic ammonium-oxidizing bacteria due to failure of the transfer of nitrogen substrates into the activated sludge beads, the activated sludge beads were prepared to have diameters of 5.06 mm, 5.96 mm and 6.50 mm and then enrichment culturing was performed. As a result, the exponential growth of the anaerobic ammonium oxidation activity was found to be different (see FIG. 10).

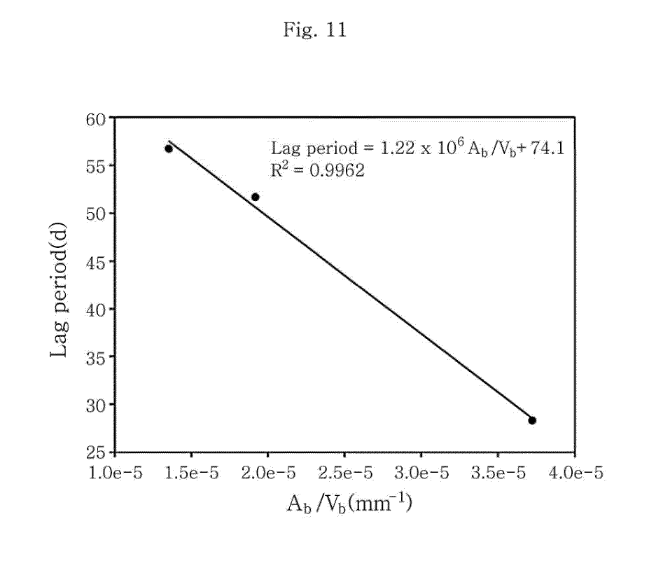

When the initial target activity was set to be 0.2 kg N/m³·day, the constant A/V (surface area/volume) of the activated sludge beads and the lag period have an inverse relationship as shown in FIG. 11. Accordingly, in order to prevent the outflow of the activated sludge beads with minimized diameter of the activated sludge beads, the activated sludge beads may be designed to have a diameter of specifically 1-2 mm.

### EXPERIMENTAL EXAMPLE 6

### Result of Long-Term Culturing

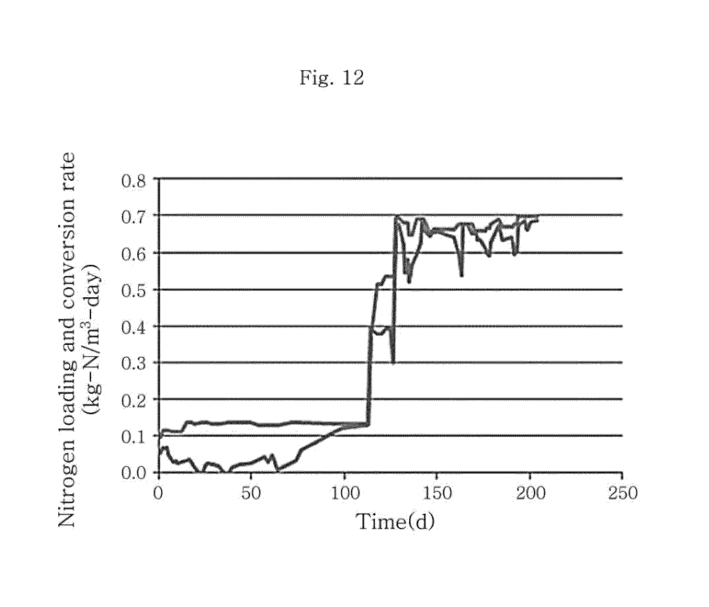

The anaerobic ammonium-oxidizing bacteria in the activated sludge beads were cultured for 200 days using a reactor having a configuration shown in FIG. 13. As seen from FIG. 12, the anaerobic ammonium-oxidizing bacteria could be cultured stably.

### DETAILED DESCRIPTION OF MAIN ELEMENTS

| | |
|---|---|
| 10: reactor | 11: stirrer |
| 12: culture medium inlet | 13: SBR outlet |
| 14: CSTR outlet | 15: filtering sieve |

What is claimed is:

1. An apparatus for enrichment culturing of anaerobic ammonium-oxidizing bacteria, comprising:
a reactor comprising a culture medium comprising ammonium and nitrite; and
activated sludge beads in which the anaerobic ammonium-oxidizing bacteria in the culture medium are supported,
wherein the amount of the activated sludge beads is 25-35% based on the volume of the culture medium.

2. The apparatus for enrichment culturing of anaerobic ammonium-oxidizing bacteria according to claim 1, wherein the reactor is operated as a completely stirred tank reactor (CSTR) and the total nitrogen inflow rate in the reactor is controlled to be 0.8-1.5 kg N/m³·day.

3. The apparatus for enrichment culturing of anaerobic ammonium-oxidizing bacteria according to claim 2, wherein the reactor is operated as a sequencing batch reactor (SBR) and the total nitrogen concentration in the culture medium in the reactor is maintained at 120-180 mg N/L.

4. The apparatus for enrichment culturing of anaerobic ammonium-oxidizing bacteria according to claim 3, wherein the pH of the culture medium is 6.5-8.

5. The apparatus for enrichment culturing of anaerobic ammonium-oxidizing bacteria according to claim 1, wherein the activated sludge beads are formed by mixing and hardening the PVA (poly(vinyl alcohol)), the alginate and the activated sludge.

6. The apparatus for enrichment culturing of anaerobic ammonium-oxidizing bacteria according to claim 1, wherein a filtering sieve preventing outflow of the activated sludge beads is provided on top of the reactor.
